(19) United States
(12) Patent Application Publication
(10) Pub. No.: US 2006/0244694 A1
(43) Pub. Date: Nov. 2, 2006

(54) Display device and driving method thereof

(75) Inventors: Nam-Deog Kim, Gyeonggi-do (KR); Kyong-Tae Park, Gyeonggi-do (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD.

(21) Appl. No.: 11/407,583

(22) Filed: Apr. 19, 2006

(30) Foreign Application Priority Data
Apr. 27, 2005 (KR) 10-2005-0034957

(51) Int. Cl. G09G 3/30

(52) U.S. Cl. 345/76

(57) ABSTRACT

A display device according to an embodiment of the present invention includes: a plurality of scanning lines; a plurality of first data lines and a plurality of second data lines, the first data lines and the second data lines intersecting the scanning lines and transmitting data voltages, the data voltages including a first type voltage and a second type voltage; a plurality of pixels, each of the pixels including a switching transistor connected to one of the scanning lines and one of the first and the second data lines, a capacitor coupled to the switching transistor, a driving transistor coupled to the switching transistor, and a light emitting element coupled to the driving transistor; and a data driver applying the first type voltage to the first data lines and the second type voltage to the second data lines during a first period.

### BACKGROUND OF THE INVENTION

(a) Field of the Invention

The present invention relates to a display device and a driving method thereof, and in particular, a light emitting diode display and a driving method thereof.

(b) Description of Related Art

Recent trends of light-weighted and thin personal computers and televisions sets also require light-weighted and thin display devices, and flat panel displays satisfying such a requirement is being substituted for conventional cathode ray tubes (CRT).

The flat panel displays include a liquid crystal display (LCD), field emission display (FED), organic light emitting diode (OLED) display, plasma display panel (PDP), and so on.

Generally, an active matrix flat panel display includes a plurality of pixels arranged in a matrix and displays images by controlling the luminance of the pixels based on given luminance information. An OLED display is a self-emissive display device that displays image by electrically exciting light emitting organic material, and it has low power consumption, wide viewing angle, and fast response time, thereby being advantageous for displaying motion images.

A pixel of an OLED display includes an OLED and a driving thin film transistor (TFT). The OLED emits light having an intensity depending on the current driven by the driving TFT, which in turn depends on the threshold voltage of the driving TFT and the voltage between gate and source of the driving TFT.

The TFT includes polysilicon or amorphous silicon. A polysilicon TFT has several advantages, but it also has disadvantages such as the complexity of manufacturing polysilicon, thereby increasing the manufacturing cost. In addition, it is hard to make an OLED display employing polysilicon TFTs be large.

On the contrary, an amorphous silicon TFT is easily applicable to a large OLED display and manufactured by less number of process steps than the polysilicon TFT. However, the threshold voltage of the amorphous silicon TFT shifts as time goes by due to a long-time application of a unidirectional voltage to a gate of the TFT such that the current flowing in the OLED is non-uniform to degrade image quality and the lifetime of the OLED is shortened.

Accordingly, several pixel circuits for compensating the shift of the threshold voltage are suggested. However, since most of the suggested pixel circuits have several TFTs and capacitors as well as several signal lines, the suggested pixel circuits may result in the reduced aperture ratio and the complicated design.

### SUMMARY OF THE INVENTION

A display device according to an embodiment of the present invention includes: a plurality of scanning lines; a plurality of first data lines and a plurality of second data lines, the first data lines and the second data lines intersecting the scanning lines and transmitting data voltages, the data voltages including a first type voltage and a second type voltage; a plurality of pixels, each of the pixels including a switching transistor connected to one of the scanning lines and one of the first and the second data lines, a capacitor coupled to the switching transistor, a driving transistor coupled to the switching transistor, and a light emitting element coupled to the driving transistor; and a data driver applying the first type voltage to the first data lines and the second type voltage to the second data lines during a first period.

The first type voltage may contain information of image to be displayed and the second type voltage may contain information for the operation of the driving transistor. The second type voltage may turn off the driving transistor, and the light emitting element may emit light having an intensity depending on the first type voltage.

The data driver may generate the data voltages and may be controlled by a selection signal.

The data driver may apply the second type voltage to the first data lines and the first type voltage to the second data lines during a second period.

The duration of each of the first period and the second period may be equal to or may be multiples of one horizontal period.

The first data lines and the second data lines may be alternately arranged. Two adjacent pixels in a row may be supplied with different types of the data voltages.

Two adjacent pixels in a column may be supplied with one of the first type voltage and the second type voltage or different types of the data voltages.

Each of the pixels may be alternately supplied with the first type voltage and the second type voltage in a frame.

The display device may further include a scanning driver applying scanning signals to the signal lines, and each of the scanning signals may have two turn-on levels in a frame.

The first type voltage and the second type voltage may have opposite polarities. The second type voltage may have a magnitude proportional to the first type voltage. The magnitude of the second type voltage may range between about 50% and about 200% of a magnitude of the first type voltage.

The second type voltage may have a substantially constant value ranging from about −20V to about 4V.

A display device according an embodiment of the present invention includes: a plurality of scanning lines; a plurality of data lines intersecting the scanning lines and transmitting a normal data voltage and a reverse bias voltage; a plurality of pixels, each of the pixels including a switching transistor connected to one of the scanning lines and one of the first and the second data lines, a capacitor coupled to the switching transistor, a driving transistor coupled to the switching transistor, and a light emitting element coupled to the driving transistor; and a data driver applying one of the normal data voltage and the reverse bias voltage to odd data lines and the other one of the normal data voltage and the reverse bias voltage to even data lines.

A frame may include a first period and a second period, and each pixel may be supplied with the normal data voltage in the first period and the reverse bias voltage in the second period, or with the reverse bias voltage in the first period and the normal data voltage in the second period.

Each of the data lines may be alternately supplied with the normal data voltage and the reverse bias voltage.

The data voltages supplied with each of the data lines may have a uniform polarity.

A method of driving a display device according to an embodiment of the present invention is provided. The display device includes a plurality of first and second data lines, and a plurality of pixels, each of the pixels including a switching transistor connected to one of the first and the second data lines, a capacitor coupled to the switching transistor, a driving transistor coupled to the switching transistor, and a light emitting element coupled to the driving transistor. The method includes: applying normal data voltages to the first data lines; applying reverse bias voltages to the second data lines; applying reverse bias voltages to the first data lines after applying reverse bias voltages to the first data lines; and applying normal data voltages to the second data lines after applying reverse bias voltages to the second data lines.

The display device may further include: applying the reverse bias voltages to control terminals of the driving transistors.

The reverse bias voltages may have polarity opposite the normal data voltages.

The application of the normal data voltage and the application of the reverse bias voltage to each of the first and the second data lines may alternate every one or more horizontal periods.

### BRIEF DESCRIPTION OF THE DRAWINGS

The present invention will become more apparent by describing embodiments thereof in detail with reference to the accompanying drawing in which:

FIG. 1 is a block diagram of an OLED display according to an embodiment of the present invention;

FIG. 2 is an equivalent circuit diagram of a pixel of an OLED display according to an embodiment of the present invention;

FIG. 3 is an exemplary sectional view of an OLED and a driving transistor shown in FIG. 2;

FIG. 4 is a schematic diagram of an OLED according to an embodiment of the present invention;

FIG. 5 is a block diagram of an exemplary data driver for an OLED display shown in FIG. 1;

FIG. 6 shows waveforms of signals for the data driver shown in FIG. 5;

FIGS. 7A and 7B show exemplary waveforms of data voltages generated by the data driver shown in FIG. 5;

FIGS. 8A, 9A, and 10A show exemplary waveforms of driving signals for an OLED display according to embodiments of the present invention; and

FIGS. 8B, 9B, and 10B are schematic diagrams illustrating normal data voltages and reverse bias voltages applied to a display panel according to the signals shown in FIGS. 8A, 9A, and 10A, respectively.

### DETAILED DESCRIPTION OF EMBODIMENTS

The present invention now will be described more fully hereinafter with reference to the accompanying drawings, in which preferred embodiments of the invention are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

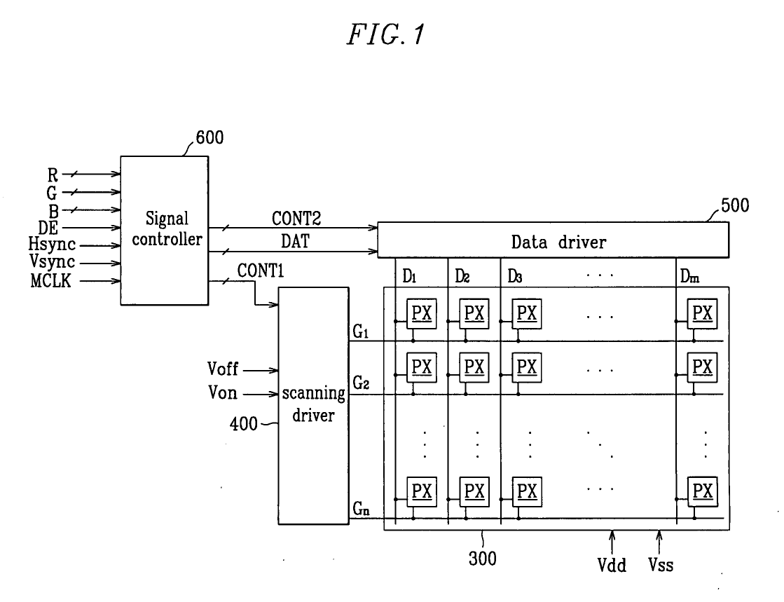

Referring to FIGS. 1-4, an organic light emitting diode (OLED) display according to an embodiment of the present invention will be described in detail.

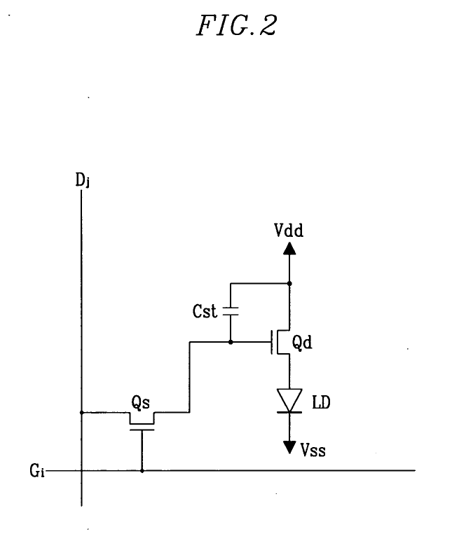

FIG. 1 is a block diagram of an OLED display according to an embodiment of the present invention and FIG. 2 is an equivalent circuit diagram of a pixel of an OLED display according to an embodiment of the present invention.

Referring to FIG. 1, an OLED display according to an embodiment includes a display panel 300, a scanning driver 400 and a data driver 500 that are connected to the display panel 300, and a signal controller 600 controlling the above elements.

Referring to FIG. 1, the display panel 300 includes a plurality of signal lines and a plurality of pixels PX connected thereto and arranged substantially in a matrix.

The signal lines include a plurality of scanning lines G₁-Gₙ transmitting scanning signals and a plurality of data lines D₁-Dₘ transmitting data voltages. The scanning lines G₁-Gₙ extend substantially in a row direction and substantially parallel to each other, while the data lines D₁-Dₘ extend substantially in a column direction and substantially parallel to each other.

Referring to FIG. 2, each pixel PX, for example, a pixel connected to a scanning line Gᵢ and a data line Dⱼ includes an OLED LD, a driving transistor Qd, a capacitor Cst, and a switching transistor Qs.

The driving transistor Qd has a control terminal connected to the switching transistor Qs, an input terminal connected to a driving voltage Vdd, and an output terminal connected to the OLED LD.

The switching transistor Qs has a control terminal connected to the scanning line Gᵢ, an input terminal connected to the data line Dⱼ, and an output terminal connected to the control terminal of the driving transistor Qd. The switching transistor Qs transmits the data voltage applied to the data line Dⱼ to the driving transistor Qd in response to the scanning signal applied to the scanning line Gᵢ.

The capacitor Cst is connected between the control terminal and the input terminal of the driving transistor Qd. The capacitor Cst stores and maintains the data voltage applied to the control terminal of the driving transistor Qd.

The OLED LD has an anode connected to the output terminal of the driving transistor Qd and a cathode connected to a common voltage Vss. The OLED LD emits light having an intensity depending on an output current I_{LD} of the driving transistor Qd. The output current I_{LD} of the driving transistor Qd depends on the voltage between the control terminal and the output terminal of the driving transistor Qd.

The switching transistor Qs and the driving transistor Qd are n-channel field effect transistors (FETs) including amorphous silicon or polysilicon. However, the transistors Qs and Qd may be p-channel FETs operating in a manner opposite to n-channel FETs.

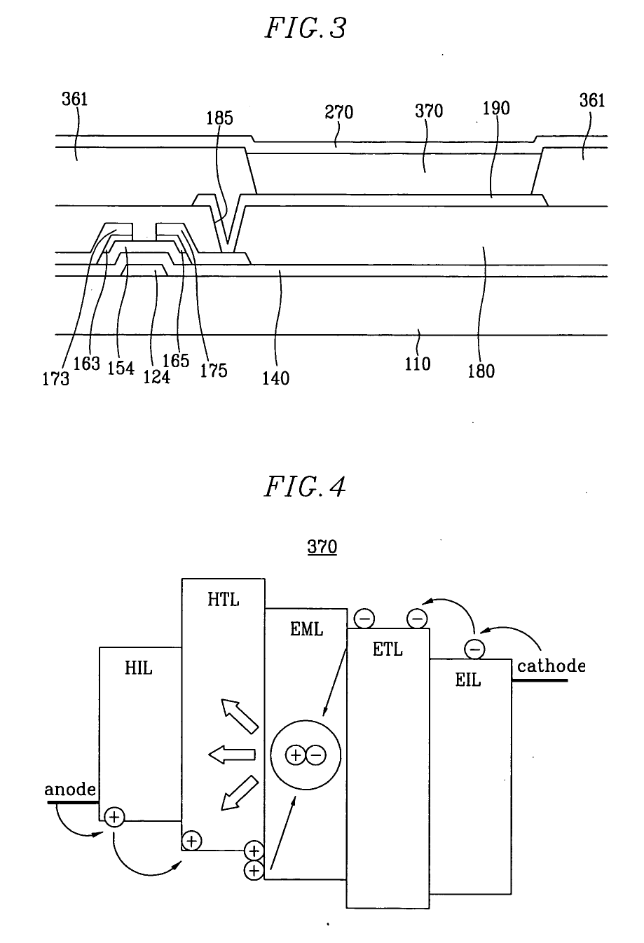

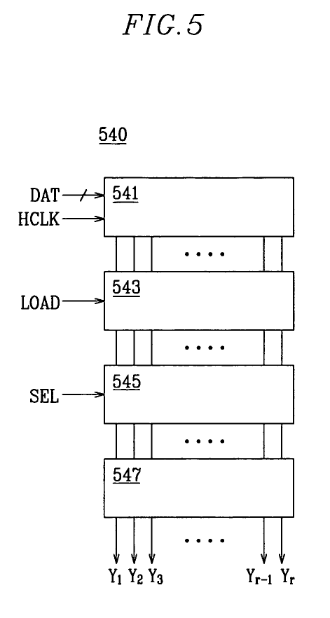

Now, a structure of an OLED LD and a driving transistor Qd connected thereto shown in FIG. 2 will be described in detail with reference to FIGS. 3 and 4.

FIG. 3 is an exemplary sectional view of an OLED LD and a driving transistor Qd shown in FIG. 2 and FIG. 4 is a schematic diagram of an OLED according to an embodiment of the present invention.

A control electrode 124 is formed on an insulating substrate 110. The control electrode 124 preferably made of Al containing metal such as Al and Al alloy, Ag containing metal such as Ag and Ag alloy, Cu containing metal such as Cu and Cu alloy, Mo containing metal such as Mo and Mo alloy, Cr, Ti or Ta. The control electrode 124 may have a multi-layered structure including two films having different physical characteristics. One of the two films is preferably made of low resistivity metal including Al containing metal, Ag containing metal, and Cu containing metal for reducing signal delay or voltage drop. The other film is preferably made of a material such as Mo containing metal, Cr, Ta or Ti, which has good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. However, the gate electrode 124 may be made of various metals or conductors. The lateral sides of the gate electrode 124 are inclined relative to a surface of the substrate, and the inclination angle thereof ranges about 30-80 degrees.

An insulating layer 140 preferably made of silicon nitride (SiNx) is formed on the control electrode 124.

A semiconductor 154 preferably made of hydrogenated amorphous silicon (abbreviated to “a-Si”) or polysilicon is formed on the insulating layer 140, and a pair of ohmic contacts 163 and 165 preferably made of silicide or n+ hydrogenated a-Si heavily doped with n type impurity such as phosphorous are formed on the semiconductor 154. The lateral sides of the semiconductor 154 and the ohmic contacts 163 and 165 are inclined relative to the surface of the substrate, and the inclination angles thereof are preferably in a range of about 30-80 degrees.

An input electrode 173 and an output electrode 175 are formed on the ohmic contacts 163 and 165 and the insulating layer 140. The input electrode 173 and the output electrode 175 are preferably made of refractory metal such as Cr, Mo, Ti, Ta or alloys thereof. However, they may have a multilayered structure including a refractory metal film (not shown) and a low resistivity film (not shown). Good example of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. Like the gate electrode 124, the input electrode 173 and the output electrode 175 have inclined edge profiles, and the inclination angles thereof range about 30-80 degrees.

The input electrode 173 and the output electrode 175 are separated from each other and disposed opposite each other with respect to a gate electrode 124. The control electrode 124, the input electrode 173, and the output electrode 175 as well as the semiconductor 154 form a TFT serving as a driving transistor Qd having a channel located between the input electrode 173 and the output electrode 175.

The ohmic contacts 163 and 165 are interposed only between the underlying semiconductor stripes 151 and the overlying electrodes 173 and 175 thereon and reduce the contact resistance therebetween. The semiconductor 154 includes an exposed portion, which are not covered with the input electrode 173 and the output electrode 175.

A passivation layer 180 is formed on the electrode 173 and 175, the exposed portion of the semiconductor 154, and the insulating layer 140. The passivation layer 180 is preferably made of inorganic insulator such as silicon nitride or silicon oxide, organic insulator, or low dielectric insulating material. The low dielectric material preferably has dielectric constant lower than 4.0 and examples thereof are a-Si:C:O and a-Si:O:F formed by plasma enhanced chemical vapor deposition (PECVD). The organic insulator may have photosensitivity and the passivation layer 180 may have a flat surface. The passivation layer 180 may be made of material having flatness characteristics and photosensitivity. The passivation layer 180 may have a double-layered structure including a lower inorganic film and an upper organic film so that it may take the advantage of the organic film as well as it may protect the exposed portions of the semiconductor 154. The passivation layer 180 has a 185 exposing a portion of the output electrode 175.

A pixel electrode 190 is formed on the passivation layer 180. The pixel electrode 190 is physically and electrically connected to the output terminal electrode 175 through the contact hole 185 and it is preferably made of transparent conductor such as ITO or IZO or reflective metal such as Cr, Ag, Al and alloys thereof.

A partition 361 is formed on the passivation layer 180. The partition 361 encloses the pixel electrode 190 to define an opening on the pixel electrode 190 like a bank, and it is preferably made of organic or inorganic insulating material.

An organic light emitting member 370 is formed on the pixel electrode 190 and it is confined in the opening enclosed by the partition 361.

Referring to FIG. 4, the organic light emitting member 370 has a multilayered structure including an emitting layer EML and auxiliary layers for improving the efficiency of light emission of the emitting layer EML. The auxiliary layers include an electron transport layer ETL and a hole transport layer HTL for improving the balance of the electrons and holes and an electron injecting layer EIL and a hole injecting layer HIL for improving the injection of the electrons and holes. The auxiliary layers may be omitted.

A common electrode 270 supplied with a common voltage Vss is formed on the organic light emitting member 370 and the partition 361. The common electrode 270 is preferably made of reflective metal such as Ca, Ba, Cr, Al or Ag, or transparent conductive material such as ITO or IZO.

A combination of opaque pixel electrodes 190 and a transparent common electrode 270 is employed to a top emission OLED display that emits light toward the top of the display panel 300, and a combination of transparent pixel electrodes 190 and an opaque common electrode 270 is employed to a bottom emission OLED display that emits light toward the bottom of the display panel 300.

A pixel electrode 190, an organic light emitting member 370, and a common electrode 270 form an OLED LD having the pixel electrode 190 as an anode and the common electrode 270 as a cathode or vice versa. The OLED LD uniquely emits one of primary color lights depending on the material of the light emitting member 380. An exemplary set of the primary colors includes red, green, and blue and the display of images is realized by the addition of the three primary colors.

Referring to FIG. 1 again, the scanning driver 400 is connected to the scanning lines G₁-Gₙ of the display panel 300 and synthesizes a high voltage Von for turning on the switching transistors Qs and a low voltage Voff for turning off the switching transistors Qs to generate scanning signals for application to the scanning lines G₁-Gₙ.

The data driver 500 is connected to the data lines D₁-Dₘ of the display panel 300 and applies data voltages to the data lines D₁-Dₘ. The data voltages include normal data voltages for displaying images and reverse bias voltage for controlling the operation of the driving transistor Qd. The reverse bias voltages alleviate the stress exerted on the driving transistor Qd, and the reverse bias voltage may turn off the driving transistor Qd.

The scanning driver 400 or the data driver 500 may be implemented as integrated circuit (IC) chip mounted on the display panel 300 or on a flexible printed circuit (FPC) film in a tape carrier package (TCP) type, which are attached to the display panel 300. Alternately, they may be integrated into the display panel 300 along with the signal lines G₁-Gₙ and D₁-Dₘ and the transistors Qd and Qs.

The signal controller 600 controls the scanning driver 400 and the data driver 500.

The signal controller 600 is supplied with input image signals R, G and B and input control signals controlling the display thereof such as a vertical synchronization signal Vsync, a horizontal synchronization signal Hsync, a main clock MCLK, and a data enable signal DE, from an external graphics controller (not shown). After generating scanning control signals CONT1 and data control signals CONT2 and processing the image signals R, G and B suitable for the operation of the display panel 300 on the basis of the input control signals and the input image signals R, G and B, the signal controller 600 sends the scanning control signals CONT1 to the scanning driver 400 and the processed image signals DAT and the data control signals CONT2 to the data driver 500.

The scanning control signals CONT1 include a scanning start signal STV for instructing the scanning driver 400 to start scanning and at least one clock signal for controlling the output time of the high voltage Von. The scanning control signals CONT1 may include a plurality of output enable signals for defining the duration of the high voltage Von.

The data control signals CONT2 include a horizontal synchronization start signal STH for informing the data driver 500 of start of data transmission for a group of pixels PX, a load signal LOAD for instructing he data driver 500 to apply the data voltages to the data lines D₁-Dₘ, a selection signal for selecting either of normal data voltages and negative bias voltage, and a data clock signal HCLK.

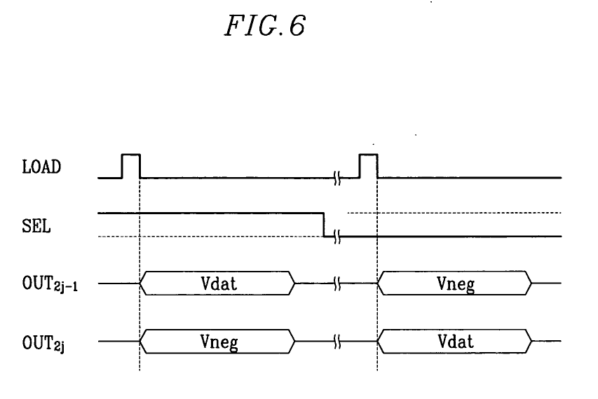

Now, a data driver according to an embodiment of the present invention will be described in detail with reference to FIGS. 5, 6, 7A and 7B.

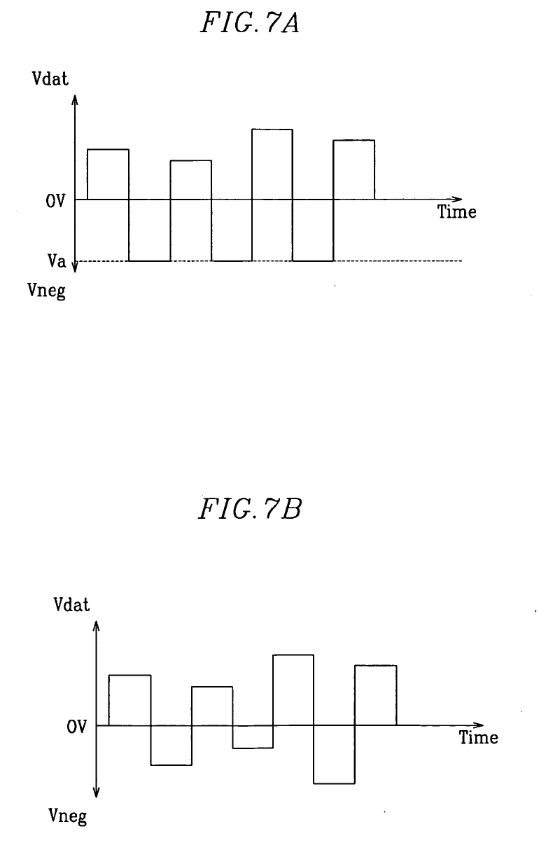

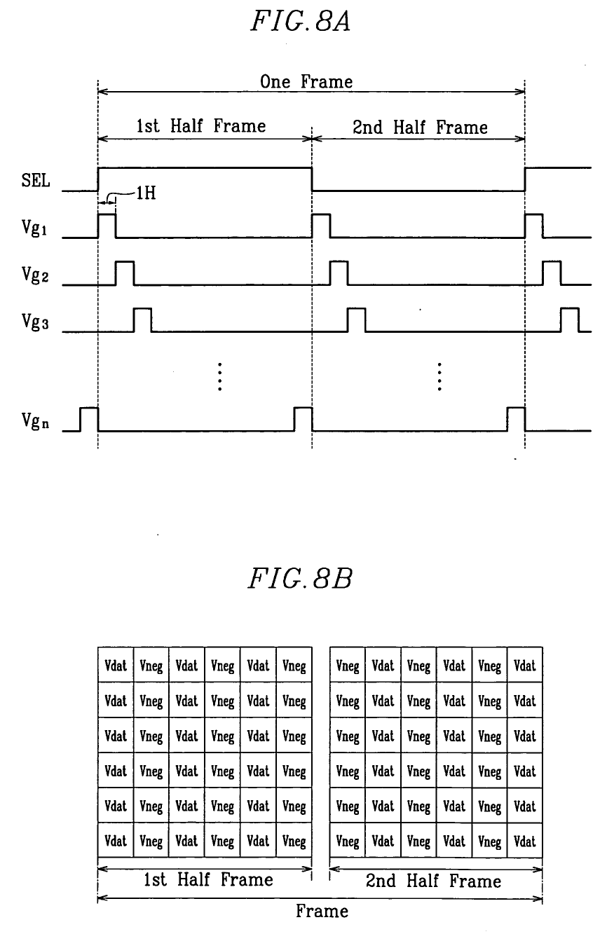

FIG. 5 is a block diagram of an exemplary data driver for an OLED display shown in FIG. 1, FIG. 6 shows waveforms of signals for the data driver shown in FIG. 5, and FIGS. 7A and 7B show exemplary waveforms of data voltages generated by the data driver shown in FIG. 5.

Referring to FIG. 5, a data driving integrated circuit (IC) 540 includes a shift register 541, a latch 543, a digital-to-analog (DA) converter 545, and a buffer 547, which are connected in series. The data driver 500 shown in FIG. 1 may include one or more data driving ICs 540.

The shift register 541 receives and shifts image data DAT to be outputted in synchronization with a data clock signal HCLK in response to a horizontal synchronization start signal (or a shift clock signal). When the data driver 500 includes two or more data driving ICs 540, the shift register 541 outputs a shift clock signal to a shift register of the next data driving IC 540 after the shift register 541 shifts all the image data DAT assigned thereto.

The latch 543 stores the image data DAT transmitted from the shift register 541 and outputs the image data DAT to the DA converter 545 in response to a load signal LOAD.

The DA converter 545 converts the digital image data DAT into analog data voltages OUT₁-OUTᵣ according to a selection signal SEL. As described above, the data voltages OUT₁-OUTᵣ include normal data voltages Vdat and the reverse bias voltage Vneg, and the reverse bias voltage Vneg has a polarity opposite that of the normal data voltages Vdat. That is, when the normal data voltages Vdat have positive values, the reverse bias voltage Vneg has a negative value.

The buffer 547 outputs the data voltages OUT₁-OUTᵣ from the DA converter 545 through output terminals Y₁-Yᵣ connected to respective data lines D₁-Dₘ. The voltage levels of the output terminals are kept constant for one horizontal period (or “1H”) (equal to one period of a horizontal synchronization signal Hsync and a data enable signal DE).

Referring to FIG. 6, the output of the data voltages OUT₁-OUTᵣ starts in synchronization with falling edges of the load signal LOAD, and either of the normal data voltages Vdat and the reverse bias voltage Vneg is chosen by the selection signal SEL. The normal data voltages Vdat and the reverse bias voltage Vneg are alternately arranged in adjacent output terminals Y₁-Yᵣ. For example, when the selection signal SEL is in a high level, odd data voltages OUT₂ₖ₋₁ (k=1, 2, . . . ) outputted from odd output terminals Y₂ₖ₋₁ are normal data voltages Vdat, while even data voltages OUT₂ₖ outputted from even output terminals Y₂₋ₖ are the reverse bias voltage Vneg. On the contrary, when the selection signal SEL is in a low level, the odd data voltages OUT₂ₖ₋₁ are the reverse bias voltage Vneg, while the even data voltages OUT₂ₖ are the normal data voltages Vdat. In other embodiments, the selection signal SEL may have opposite levels.

The reverse bias voltage Vneg, as shown in FIG. 7A, may have a fixed value Va. The fixed value Va may range between −20V and −4V, and the absolute value of the reverse bias voltage may be equal to about the average of the normal data voltages Vdat or may be larger than the maximum of the normal data voltages Vdat. The reverse bias voltage Vneg, as shown in FIG. 7B, has a magnitude proportional to the normal data voltages Vdat that is (to be) applied to the driving transistor Qd. The reverse bias voltage Vneg may be about 50% to about 200% of the normal data voltages Vdat. The reverse bias voltage Vneg may be determined in consideration of the range of the normal data voltages Vdat and design factors such as types and characteristics of the OLED LD.

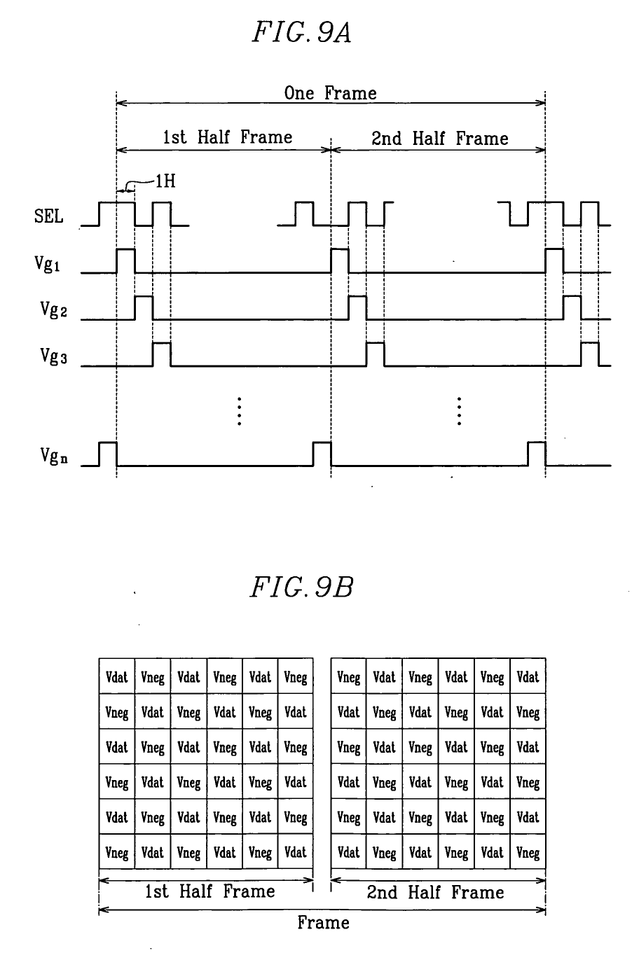

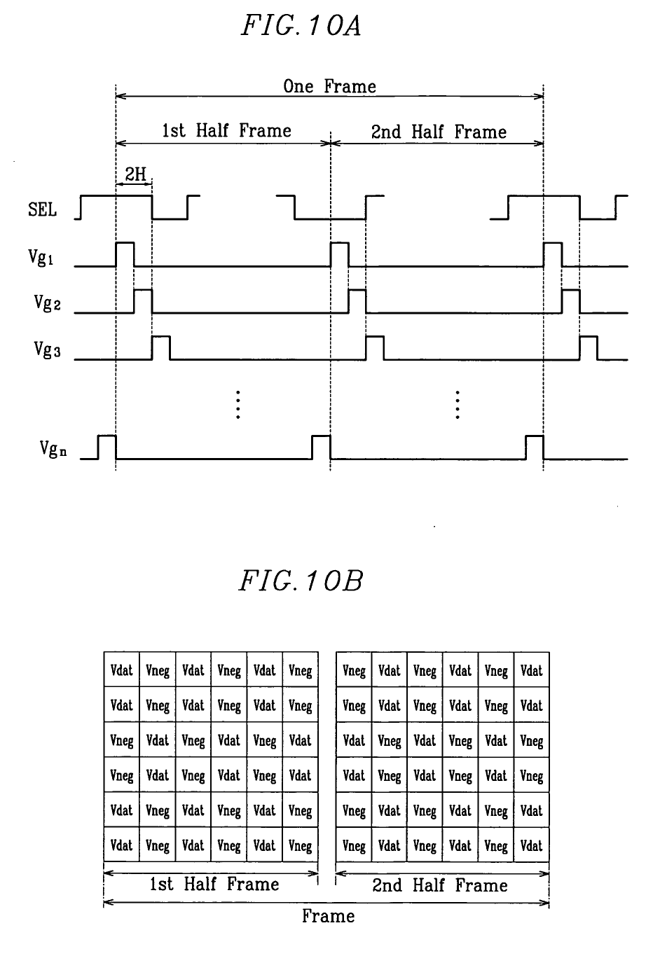

The operation of an OLED display according to an embodiment of the present invention will be described in detail with reference to FIGS. 8A, 8B, 9A, 9B, 10A and 10B.

FIGS. 8A, 9A, and 10A show exemplary waveforms of driving signals for an OLED display according to embodiments of the present invention, and FIGS. 8B, 9B, and 10B are schematic diagrams illustrating normal data voltages and reverse bias voltages applied to a display panel according to the signals shown in FIGS. 8A, 9A, and 10A, respectively.

Referring to FIGS. 8A-10B, the signal generator 600 controls the display of images after dividing a frame into a first half frame and a second half frame.

Referring to FIGS. 8A and 8B, the selection signal SEL is constant in each of the first half frame and the second half frame. During the first half frame, the selection signal SEL is in a high level, while it is in a low level in the second half frame.

Referring to FIGS. 9A-10B, the selection signal SEL swings between a high level and a low level in each of the first half frame and the second half frame. The selection signal SEL shown in FIGS. 9A and 9B has a period of 2H, and the selection signal SEL shown in FIGS. 10A and 10B has a period of 4H. The phase of the selection signal SEL relative to the scanning signals V_{g1}-V_{gn} is reversed (or has a difference of 180 degrees) between the first half frame and the second half frame.

Responsive to the selection signal SEL and the data control signals CONT2 from the signal controller 600, the data driver 500 receives a packet of the image data DAT for a group of pixels from the signal controller 600, converts the image data DAT into normal data voltages Vdat and reverse bias voltage Vneg, and applies the data voltages Vdat and Vneg to the data lines D₁-Dₘ. Odd data lines D₂ₖ₋₁ may be supplied with the normal data voltages Vdat, while even data lines D₂ₖ may be supplied with the reverse bias voltage Vneg when the selection signal SEL is in a high level.

The scanning driver 400 applies the high voltage Von to the scanning line G₁-Gₙ in response to the scan control signals CONT1 from the signal controller 600, thereby turning on the switching transistors Qs connected thereto. Reference numerals Vg1-Vgn denote scanning signals having a high voltage level Von and a low voltage level. The normal data voltages Vdat and the reverse bias voltage Vneg applied to the data lines D₁-Dₘ are supplied to the control terminals of the driving transistor Qd and the capacitors Cst through the activated switching transistors Qs and the capacitors Cst store the data voltages Vdat and Vneg. The voltages of the capacitors Cst are maintained to keep the voltages between the control terminals and the output terminals of the driving transistors Qd after the switching transistors Qs are turned off.

Each of the driving transistors Qd supplied with the normal data voltages Vdat turns on to output an output current I_{LD} having a magnitude depending on the data voltages such that the OLEDs LD emits light having intensity depending on the output current I_{LD}, thereby displaying images. However, the driving transistors Qd supplied with the reverse bias voltages Vneg turn off such that the OLEDs LD do not emit light.

By repeating this procedure by a unit of a horizontal period, all scanning lines G₁-Gₙ are sequentially supplied with the high voltage Von during the first half frame, thereby applying the data voltages Vdat and Vneg to all pixels.

The type of the data voltages Vdat and Vneg is changed every column in FIG. 8B, every row and every column in FIG. 9B, and every two rows and every column in FIG. 10B. These arrangements of the data voltages Vdat and Vneg are determined by the waveforms of the selection signals SEL shown in FIGS. 8A, 9A and 10A.

In detail, the outputs of the data driving IC 540 shown in FIG. 5 are established so that the type of the data voltages Vdat and Vneg is changed by every column. Since the selection signal SE shown in FIG. 8A has a fixed value in each of the first half frame and the second half frame, the type of the data voltages Vdat and Vneg is fixed in each half frame. The selection signal SE shown in FIG. 9A has a period of 2H to change the type of the data voltages Vdat and Vneg every row, and the selection signal SE shown in FIG. 10A has a period of 4H to change the type of the data voltages Vdat and Vneg every two rows.

In the second half frame, the selection signal SEL for each pixel row has a value opposite to that in the first half frame. Therefore, each pixel PX is supplied with a different type of the data voltages Vdat and Vneg from that in the first half frame. For example, a pixel supplied with a normal data voltage Vdat in the first half frame will be supplied with a reverse bias voltage Vneg in the second half frame.

By adjusting the period of the selection signal SEL, the arrangement of the normal data voltages Vdat and the reverse bias voltage Vneg can be varied. For example, the type of the data voltages Vdat and Vneg may be altered every three or more rows.

The reverse bias voltage Vneg applied to the control terminal of the driving transistor Qd can reduce the shift of the threshold voltage of the driving transistor Qd. That is, the reverse bias voltage Vneg alleviates the stress due to the application of the positive normal data voltages for displaying images to reduce the shift of the threshold voltage of the driving transistor Qd.

In the meantime, since the scanning of the gate lines G₁-Gₙ is performed twice in a frame, the actual frame frequency of the OLED display according to this embodiment is twice the frame frequency of the input image data R, G and B.

The signal generator 600 may include a frame memory (not shown) for storing the image data.

As described above, each pixel PX emits light for a half frame and stops the light emission for another half frame. Such an operation gives an effect of impulsive driving to reduce blurring of images.

The normal data voltages Vdat and the reverse bias voltage Vneg are applied in various patterns to reduce the shift of the threshold voltage of the driving transistors Qd and to improve image quality.

Since there is no additional element such as transistor or signal line, the aperture ratio can be remained.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A display device comprising:
a plurality of scanning lines;
a plurality of first data lines and a plurality of second data lines, the first data lines and the second data lines intersecting the scanning lines and transmitting data voltages, the data voltages including a first type voltage and a second type voltage;
a plurality of pixels, each of the pixels including a switching transistor connected to one of the scanning lines and one of the first and the second data lines, a capacitor coupled to the switching transistor, a driving transistor coupled to the switching transistor, and a light emitting element coupled to the driving transistor; and
a data driver applying the first type voltage to the first data lines and the second type voltage to the second data lines during a first period.

2. The display device of claim 1, wherein the first type voltage contains information of image to be displayed and the second type voltage contains information for the operation of the driving transistor.

3. The display device of claim 2, wherein the second type voltage turns off the driving transistor.

4. The display device of claim 2, wherein the light emitting element emits light having an intensity depending on the first type voltage.

5. The display device of claim 2, wherein the data driver generates the data voltages and is controlled by a selection signal.

6. The display device of claim 2, wherein the data driver applies the second type voltage to the first data lines and the first type voltage to the second data lines during a second period.

7. The display device of claim 6, wherein duration of each of the first period and the second period is equal to or is multiples of one horizontal period.

8. The display device of claim 2, wherein the first data lines and the second data lines are alternately arranged.

9. The display device of claim 8, wherein two adjacent pixels in a row are supplied with different types of the data voltages.

10. The display device of claim 2, wherein two adjacent pixels in a column are supplied with one of the first type voltage and the second type voltage.

11. The display device of claim 2, wherein two adjacent pixels in a column are supplied with different types of the data voltages.

12. The display device of claim 2, wherein each of the pixels is alternately supplied with the first type voltage and the second type voltage in a frame.

13. The display device of claim 2, further comprising a scanning driver applying scanning signals to the signal lines, each of the scanning signals have two turn-on levels in a frame.

14. The display device of claim 2, wherein the first type voltage and the second type voltage have opposite polarities.

15. The display device of claim 14, wherein the second type voltage has a magnitude proportional to the first type voltage.

16. The display device of claim 15, wherein a magnitude of the second type voltage range between about 50% and about 200% of a magnitude of the first type voltage.

17. The display device of claim 14, wherein the second type voltage has a substantially constant value.

18. The display device of claim 17, wherein the second type voltage ranges from about −20V to about −4V.

19. A display device comprising:
a plurality of scanning lines;
a plurality of data lines intersecting the scanning lines and transmitting a normal data voltage and a reverse bias voltage;
a plurality of pixels, each of the pixels including a switching transistor connected to one of the scanning lines and one of the first and the second data lines, a capacitor coupled to the switching transistor, a driving transistor coupled to the switching transistor, and a light emitting element coupled to the driving transistor; and
a data driver applying one of the normal data voltage and the reverse bias voltage to odd data lines and the other one of the normal data voltage and the reverse bias voltage to even data lines.

20. The display device of claim 19, wherein a frame includes a first period and a second period, and each pixel is supplied with the normal data voltage in the first period and the reverse bias voltage in the second period, or with the reverse bias voltage in the first period and the normal data voltage in the second period.

21. The display device of claim 19, wherein each of the data lines is alternately supplied with the normal data voltage and the reverse bias voltage.

22. The display device of claim 19, wherein the data voltages supplied with each of the data lines have a uniform polarity.

23. A method of driving a display device including a plurality of first and second data lines, and a plurality of pixels, each of the pixels including a switching transistor connected to one of the first and the second data lines, a capacitor coupled to the switching transistor, a driving transistor coupled to the switching transistor, and a light emitting element coupled to the driving transistor, the method comprising:
applying normal data voltages to the first data lines;
applying reverse bias voltages to the second data lines;
applying reverse bias voltages to the first data lines after applying reverse bias voltages to the first data lines; and
applying normal data voltages to the second data lines after applying reverse bias voltages to the second data lines.

24. The display device of claim 23, further comprising:
applying the reverse bias voltages to control terminals of the driving transistors.

25. The display device of claim 24, wherein the reverse bias voltages have polarity opposite the normal data voltages.

26. The display device of claim 25, wherein the application of the normal data voltage and the application of the reverse bias voltage to each of the first and the second data lines alternate every one or more horizontal periods.
